(19) United States
(12) Patent Application Publication
(10) Pub. No.: US 2026/0316486 A1
(43) Pub. Date: Oct. 15, 2026

(54) DRAWING ASSISTANCE TOOL

(71) Applicant: Aidan Cengiz Ergun, Springfield, OR (US)

(72) Inventor: Aidan Cengiz Ergun, Springfield, OR (US)

(21) Appl. No.: 19/648,480

(22) Filed: Apr. 15, 2026

Related U.S. Application Data
(60) Provisional application No. 63/789,109, filed on Apr. 15, 2025.

(51) Int. Cl. B44B 3/06; B43L 7/00

(52) U.S. Cl. CPC B44B 3/063; B43L 7/007

(57) ABSTRACT

A magnetic rotating ruler system for drawing lines with improved precision. The system can include a base module having an integrated rotation mechanism that can enable 360-degree rotation. A ferromagnetic metal disc is positioned beneath a work surface to provide an anchor point for a magnetic connection at the bottom of the base module through the work surface. The exterior of the base module features a magnetic connection point on a rotating top piece configured to attach to one or more rulers. These rulers can comprise a straight edge and magnetic fastening devices at one or both ends, allowing multiple rulers to be connected end-to-end and/or directly to the base module. Users can anchor the base module to the metal disc through the work surface, attach a ruler, and rotate it 360 degrees to achieve a desired drawing angle.

### CROSS-REFERENCE TO RELATED APPLICATIONS

This application claims the benefit of U.S. Provisional Patent Application No. 63/789,109, filed on Apr. 15, 2025.

### INCORPORATION BY REFERENCE

The disclosure of U.S. Provisional Patent Application No. 63/789,109, which was filed on Apr. 15, 2025, is hereby incorporated by reference for all purposes as if presented herein in its entirety.

### BACKGROUND OF THE DISLCOSURE

In some examples, a ruler system can lack the adjustability and versatility desired for drawing and drafting tasks (e.g., those with increased complexity). Such systems can be cumbersome to position accurately can be complicated to use, and they may not provide the range of angles desired or offer a stable base, such as for precision work. Therefore, there is a need for an adjustable ruler system that can help to provide an increased precision in positioning, a range of angles, and a stable, secure base.

### BRIEF SUMMARY OF THE DISLCOSURE

In general, one aspect of the disclosure is directed to a drawing tool. The drawing tool can include a circular base module with an integrated rotating mechanism that allows for rotation. The circular base module contains a magnet on its exterior surface that allows for the attachment of rulers. The rulers can be connected to each other via magnetic fastening devices at their ends to create extended measuring tools. A small metal disc positioned beneath the paper or work surface provides an anchor point for the magnetic base module. This design can help to provide an adjustable ruler positioning for drawing lines at desired angles.

In another aspect, the disclosure is generally directed to a magnetic rotating ruler system. The ruler system can comprise a base module comprising a top piece and a rotation mechanism. The rotation mechanism can be configured to allow 360-degree rotation of the top piece. A magnet can be embedded in the top piece. The ruler system further can include at least one ruler comprising a magnetic fastening device for removably mounting the at least one ruler to the magnet in the top piece and a metal disc configured to be positioned beneath a work surface.

In another aspect, the disclosure is generally directed to a method of using a magnetic rotating ruler system. The method can comprise placing a metal disc beneath a work surface, positioning a base module on the work surface above the metal disc, attaching a ruler to a rotatable portion of the base module, rotating the ruler to a desired angle, and drawing a line along an edge of the ruler.

In another aspect, the disclosure is generally directed to a drawing assistance tool. The drawing assistance tool can comprise a base module comprising a top piece and a base piece. The top piece can be rotatable relative to the base piece about an axis. A magnetic connection point can be at least partially held by the base piece. A ruler can be removably mounted to the top piece so that the ruler is rotatable about the axis with the top piece. An anchor piece can be configured to be magnetically connected to the base module by the magnetic connection point with at least a portion of a work surface extending between the anchor piece and the base module.

Additional aspects, features, and advantages of the present invention will become apparent from the following description and accompanying figures.

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is an isometric exploded view of the circular base module showing the rotating mechanism according to exemplary embodiments of the disclosure.

FIG. 2 is a cross-section of the circular base module illustrating the integration of components according to the exemplary embodiments of the disclosure.

FIG. 3 is a top-down view of the system with rulers attached according to the exemplary embodiments of the disclosure.

FIG. 4 is a perspective side view showing placement of the metal disc beneath the paper according to the exemplary embodiments of the disclosure.

FIGS. 5A and 5B are plan views of the system illustrating a sequence demonstrating ruler extension capabilities according to the exemplary embodiments of the disclosure.

FIG. 6 is a usage diagram showing application for geometric drawing according to the exemplary embodiments of the disclosure.

FIG. 7 is a view of two ruler systems arranged in a storage assembly according to the exemplary embodiments of the disclosure.

Corresponding parts are designated by corresponding reference numbers throughout the drawings.

### DETAILED DESCRIPTION OF THE EXEMPLARY EMBODIMENTS

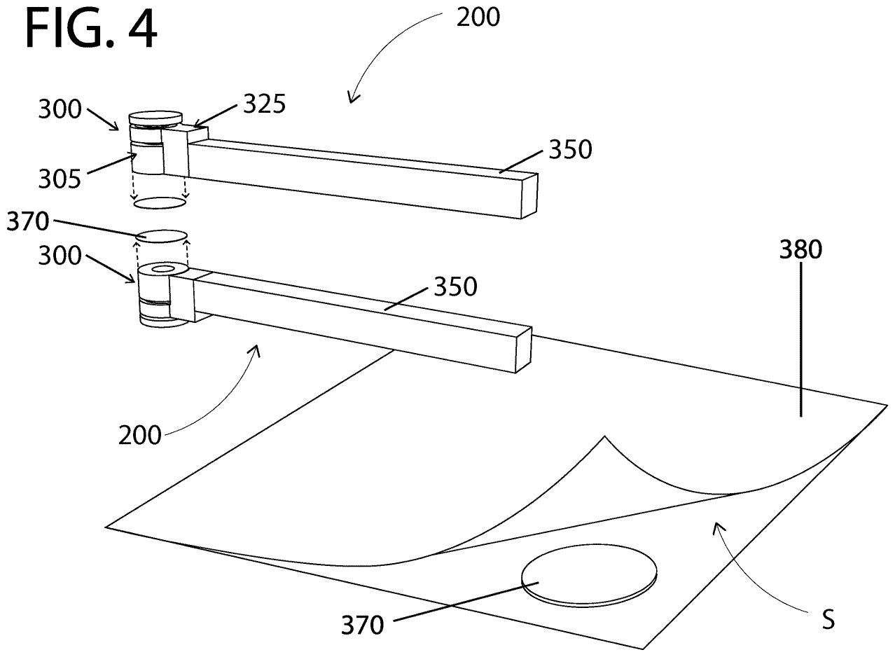

The present disclosure generally relates to a drawing assistance tool and the method of using the drawing assistance tool. In embodiments, the disclosure includes a magnetic rotating ruler system configured to assist in the drawing of lines and angles (e.g., facilitating the precise drawing of lines and angles). The ruler system can be used in place of and/or in addition to other assistive devices, such as protractors, fixed rulers, etc. As shown in FIGS. 4-6, the ruler system 200 can include a base module (300), one or more rulers (350), and an anchor piece or metal disc (370).

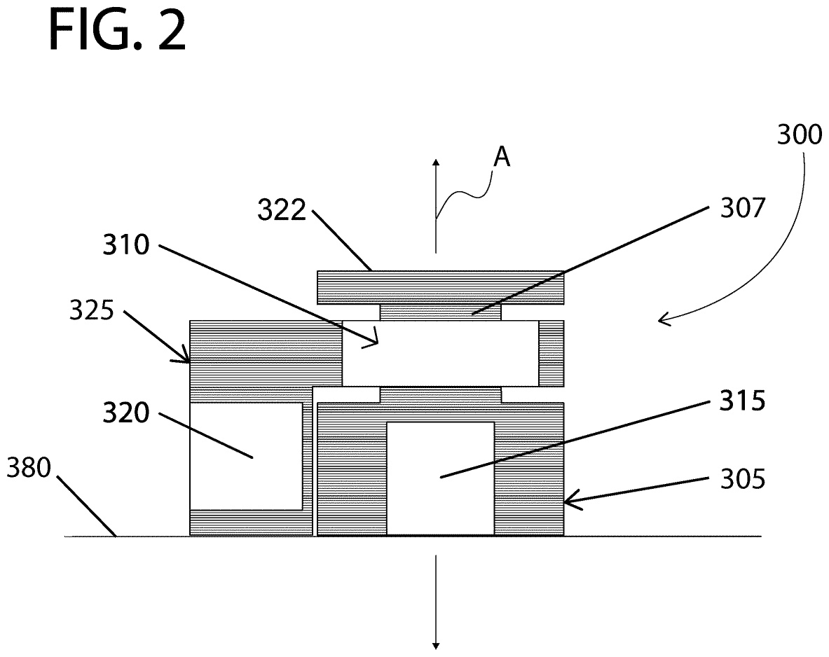

In the illustrated embodiments, the base module (300) can have a circular shape and can have a characteristic dimension D (e.g., a diameter) of approximately 0.75 inches. For example, the diameter D could be in the range of approximately 0.25 inches to approximately 0.75 inches, of approximately 0.3 inches to approximately 0.6 inches, of approximately 0.5 inches to approximately 0.75 inches, of approximately 0.25 inches to approximately 0.4 inches, and/or any other suitable range. In embodiments, the base module 300 can include a base piece (305) configured to be selectively secured on a work surface (380) (FIG. 4) and a top piece 325 that can be rotatable relative to the base piece 305. In embodiments, the work surface 380 could be a piece of paper, a canvas, and/or another suitable drawing material or another suitable working material. As shown in FIG. 2, a bottom magnetic connection point 315 can be located at the bottom of the base piece (305) for interacting with the metal disc 370. For example, the magnetic connection point (315) could be a permanent magnet or other suitable feature that can be secured within a bore extending from the bottom surface of the base piece 305 (e.g., by adhesive, interference fit, overmolding, etc.) (FIG. 2).

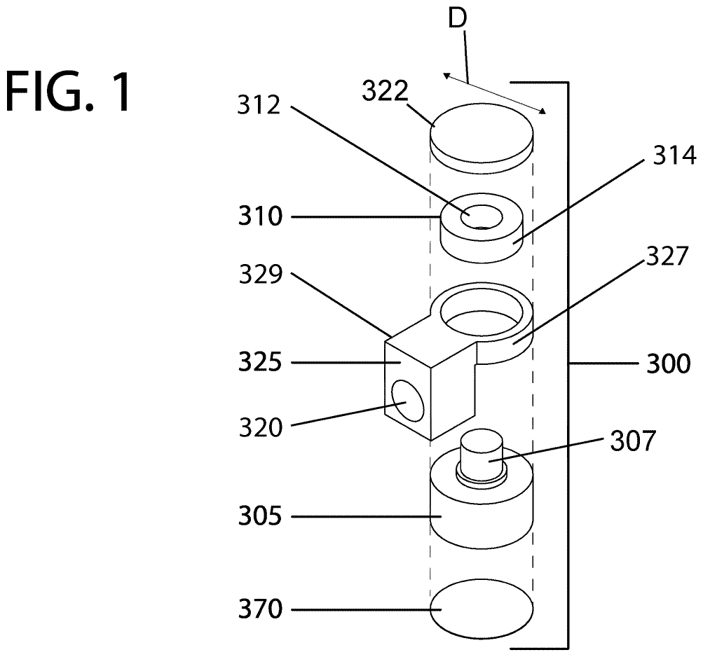

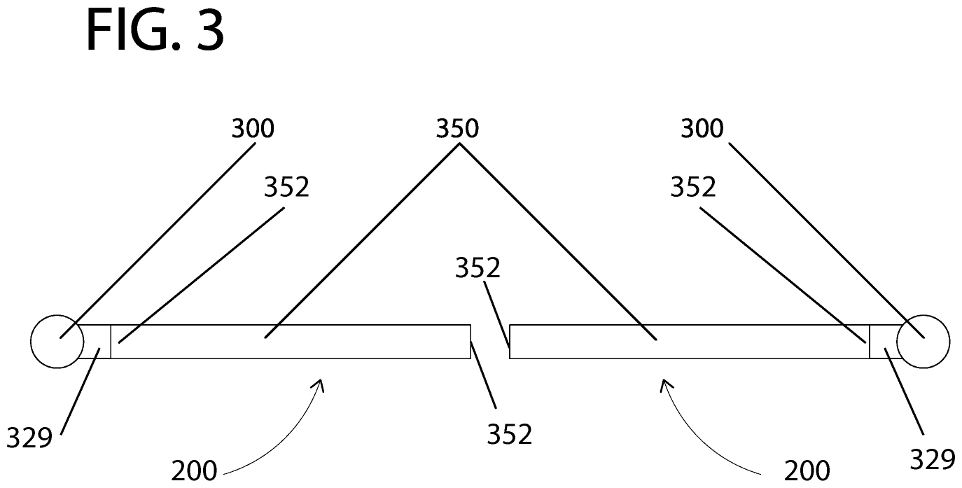

As shown in FIG. 1, the base module (300) can include a rotating mechanism (310), such as a bushing, a bearing, and/or other suitable apparatus that can facilitate the relative rotation of the top piece 325 relative to the base piece 305. As shown in FIGS. 1 and 2, this rotating mechanism (310) can be mounted onto an extension or shaft 307 extending from the base piece 305 and can be mounted within a support ring 327 of the top piece 325. For example, the rotating mechanism 310 can be a bearing with an inner race 312 that can be pressed onto the shaft 307 of the base piece (305), and then the support ring 327 of the top piece (325) can be fastened on top of the rotating mechanism (310) (e.g., can be adhered and/or otherwise secured to an outer race 314 of the rotating mechanism 310). As shown in FIGS. 1 and 2, an exterior magnetic connection point (320) can be embedded in a side part 329 of the rotating top piece (325) for interacting with one or more of the rulers (350) (FIGS. 3 and 4). For example, the exterior magnetic connection point (320) could be a permanent magnet or other suitable feature that can be secured within a bore extending from a side face of the top piece 325 (e.g., by adhesive, interference fit, overmolding, etc.) (FIG. 2). As shown in FIGS. 1 and 2, the base module 300 can include a cap 322 or other suitable feature that can be secured to a top of the base module 300 (e.g., on a top end of the shaft 307). The base module 300, including at least the base piece 305, the top piece 325, the rotating mechanism 320, and/or the cap 322 could be otherwise sized, shaped, arranged, positioned, and/or configured without departing from the disclosure.

To secure the ruler system 200, the metal disc (370) can be positioned beneath the paper or other suitable work surface (380) on top of a support surface S, such as a table or a desk, etc. (FIG. 4). In the illustrated embodiments, the metal disc (370) can be made of a ferromagnetic material, serving as an anchor point for the magnetic connection point (315) of the circular base module (300). as shown in FIG. 1, the metal disc (370) can be sized to match the footprint of the circular base module (300). The metal disc 370 could be otherwise shaped, arranged, positioned, and/or configured without departing from the disclosure.

In exemplary embodiments, the magnetic connection point (315) is configured to magnetically attract the metal disc (370) through the work surface (380), thereby at least partially securing the circular base module (300) to the work surface (380) without requiring direct contact between the magnetic connection point (315) and the metal disc (370). In embodiments, the magnetic attraction is sufficient to hold the circular base module (300) stationary during drawing operations while the work surface (380) remains interposed between the base piece (305) and the metal disc (370). This through-surface anchoring allows the user to place the metal disc (370) at any desired location beneath the work surface (380), providing unrestricted positioning of the pivot point for the rotating rulers (350).

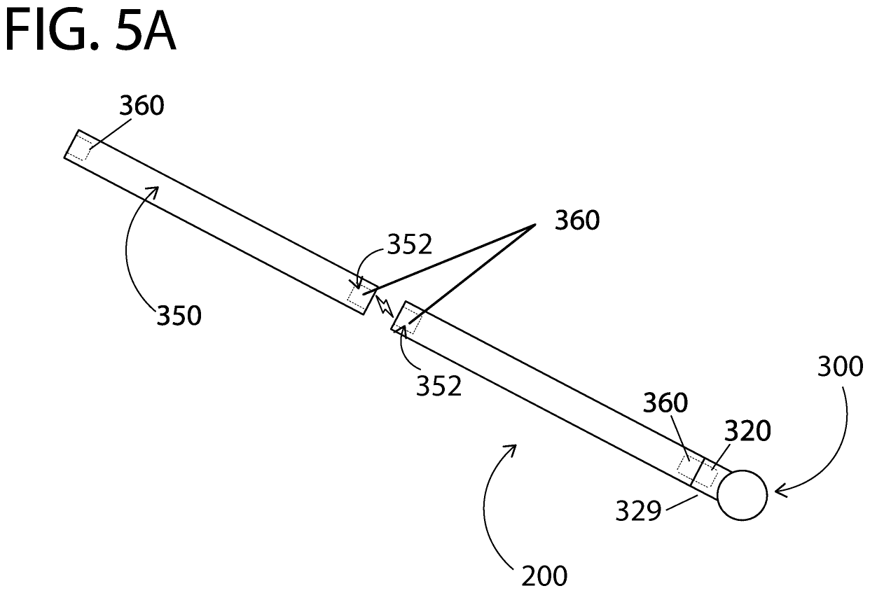

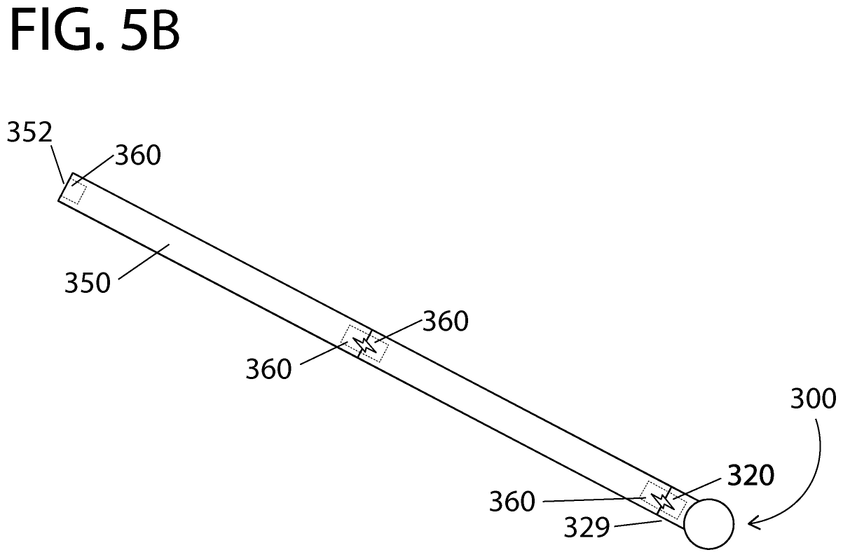

As shown in FIGS. 3-6, the ruler system 200 can include one or more rulers (350). Each ruler (350) can include a straight edge or other suitable edge for drawing lines and/or measuring. As shown in FIGS. 5A and 5B, a magnetic fastening device 360 (shown in hidden lines in FIGS. 5A and 5B) can be located on both ends 352 of the rulers (350). In exemplary embodiments, the magnetic fastening device (360) can be configured to attach to the exterior magnetic connection point (320) of the circular base module (300) and/or to the magnetic fastening device (360) of an additional ruler (350). For example, as shown in FIGS. 5A and 5B, an additional ruler 350 can be secured to the end of the ruler 350 of a ruler system 200 (FIG. 5A) to form an extended ruler system 200′ (FIG. 5B) in which the rulers 350 are connected by the magnetic fastening devices 360 at their respective ends. The rulers 350 could be otherwise shaped, arranged, positioned, and/or configured without departing from the disclosure.

In operation, a user places the metal disc (370) beneath a paper or other suitable work surface (380) at a desired location (FIG. 4). The circular base module (300) can be positioned on top of the work surface (380) and aligned with the metal disc 370. In embodiments, the bottom magnetic connection point 315 can anchor the base module 300 to the metal disc (370) through the work surface 380 via magnetic attraction. In embodiments, the magnetic coupling of the metal disc 370 or anchor piece with the base module 300 with the work surface 380 between these pieces can allow the ruler system 200 to be secured to the work surface 380 without damaging it or with a lower likelihood of damaging it. An end 353 of one of the rulers (350) then can be secured to the exterior magnetic connection point (320) via magnetic attraction with the magnetic fastening device 360 at the respective end 352 of the ruler 350.

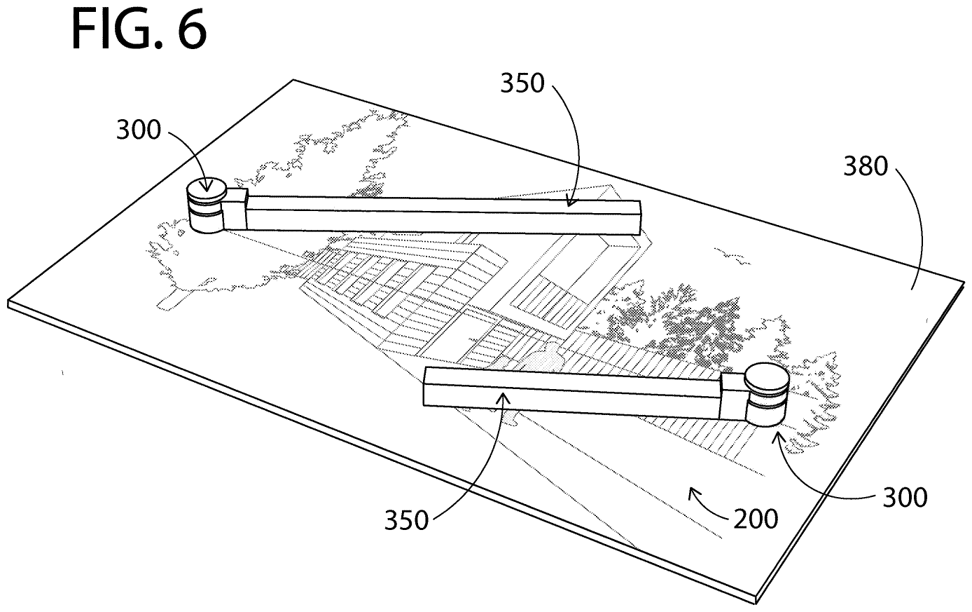

Once attached, the rotating top piece (325) allows the user to rotate the ruler 360 degrees to position it at any desired angle. For example, the top piece 325 can rotate relative to the shaft 307 of the base piece 305 via the rotating mechanism 310 so that the top piece 325 and the ruler 350 can rotate about an axis A (FIG. 2) of the base piece 305. The user can then draw a line along the straight edge of the ruler (350). Furthermore, multiple rulers (350) can be connected end-to-end to extend the measuring edge (FIG. 5B) or create complex geometric configurations. Additionally, multiple circular base modules (300) can be used simultaneously on a single work surface (380) (FIG. 6).

In one application, the magnetic rotating ruler system is used for perspective drawing. A user positions the metal disc (370) beneath the work surface (380) at a location corresponding to a desired vanishing point. The circular base module (300) is then anchored to the metal disc (370) through the work surface (380), establishing a fixed pivot at the vanishing point. The user attaches a ruler (350) to the exterior magnetic connection point (320) and rotates the ruler (350) to draw converging lines that radiate from the vanishing point. For multi-point perspective drawing, a user positions a second metal disc (370) and a second circular base module (300) at a second vanishing point location on the work surface (380), enabling the simultaneous drawing of lines converging to two or more vanishing points. This configuration supports one-point, two-point, and three-point perspective drawing techniques.

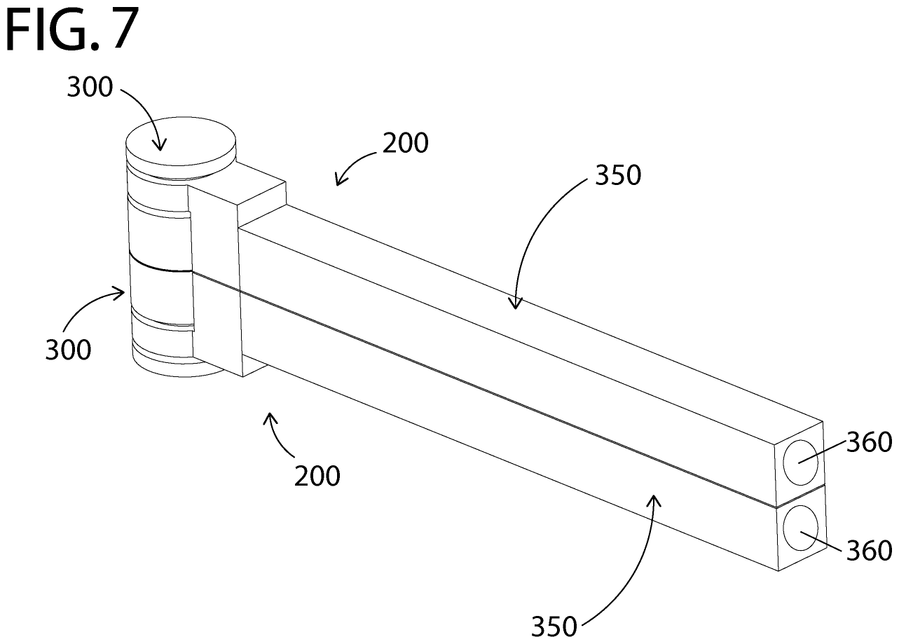

When not in use, the magnetic fastening devices (360) on the rulers (350) enable the rulers (350) to be magnetically stacked together in a compact configuration for storage and portability. For example, as shown in FIG. 7, two ruler systems 200 can be stacked together to form a storage assembly or stack, with the bottoms of the base modules 300 facing one another and the bottoms of the rulers 350 facing one another. In exemplary embodiments, the magnetic attraction between the magnets 360 of adjacent rulers (350) can help hold the stack securely while allowing individual rulers (350) and/or ruler systems 200 to be easily separated for use. In embodiments, the metal discs 370 of each of the ruler systems 200 can be magnetically secured to the respective base modules 300 by the magnets 315 in the respective base pieces 305 (e.g., so that the discs 370 are positioned between the base modules 300 in the stack shown in FIG. 7). The ruler systems 200 could be otherwise assembled without departing from the disclosure. For example, two or more rulers 350 can be arranged in a stack without the base modules 300.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments. Additionally, the disclosure shows and describes only selected embodiments, but various other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

1. A magnetic rotating ruler system comprising:
a base module comprising a top piece and a rotation mechanism, the rotation mechanism being configured to allow 360-degree rotation of the top piece;
a magnet embedded in the top piece;
at least one ruler comprising a magnetic fastening device for removably mounting the at least one ruler to the magnet in the top piece; and
a metal disc configured to be positioned beneath a work surface.

2. The magnetic rotating ruler system of claim 1, wherein the at least one ruler comprises a plurality of rulers, each including magnetic fastening devices located at respective ends of the respective ruler, enabling connection between two or more rulers of the plurality of rulers.

3. The magnetic rotating ruler system of claim 1, wherein the base module has a diameter of approximately 0.75 inches.

4. The magnetic rotating ruler system of claim 1, wherein the base module further comprises a base piece, and wherein the rotation mechanism is pressed onto a portion of the base piece to rotate within the base module.

5. The magnetic rotating ruler system of claim 1, further comprising at least a second base module configured for simultaneous use on the work surface.

6. The magnetic rotating ruler system of claim 1, wherein at least one ruler is configured to attach to a portion of the circular base module via magnetic attraction.

7. The magnetic rotating ruler system of claim 1, wherein the metal disc comprises a size configured to match a footprint of the base module.

8. The magnetic rotating ruler system of claim 1, wherein the base module further comprises a magnetic connection point that is configured to magnetically attract the metal disc through the work surface, removably securing the base module to the work surface.

9. The magnetic rotating ruler system of claim 1, wherein the metal disc is positioned at a location corresponding to a vanishing point on the work surface, and the ruler is rotatable about the vanishing point for perspective drawing.

10. The magnetic rotating ruler system of claim 1, wherein the at least one ruler comprises a plurality of rulers, and wherein the magnetic fastening device on each of the rulers is configured to cooperate with the magnetic fastening device of adjacent rulers to facilitate magnetically stacking the rulers together in a compact configuration for storage and portability.

11. A method of using a magnetic rotating ruler system, the method comprising:
placing a metal disc beneath a work surface;
positioning a base module on the work surface above the metal disc;
attaching a ruler to a rotatable portion of the base module;
rotating the ruler to a desired angle; and
drawing a line along an edge of the ruler.

12. The method of claim 11, wherein the ruler is a first ruler, and wherein the method further comprises connecting a second ruler to the first ruler via one or more magnetic fastening devices to extend a measuring edge of the magnetic rotating ruler system.

13. A drawing assistance tool, comprising:
a base module comprising a top piece and a base piece, the top piece being rotatable relative to the base piece about an axis, wherein a magnetic connection point is at least partially held by the base piece;
a ruler removably mounted to the top piece so that the ruler is rotatable about the axis with the top piece; and
an anchor piece configured to be magnetically connected to the base module by the magnetic connection point with at least a portion of a work surface extending between the anchor piece and the base module.

14. The drawing assistance tool of claim 13, wherein the ruler is magnetically connected to the top piece of the base module.

15. The drawing assistance tool of claim 13, wherein the top piece comprises a support ring, the base piece comprises a shaft, and the support ring is rotatably mounted to the shaft by a rotating mechanism for facilitating rotation of the top piece relative to the base piece.

16. The drawing assistance tool of claim 13, wherein the ruler is a first ruler, the drawing assistance tool further comprises a second ruler, and wherein the second ruler is magnetically connected to an end of the first ruler opposite to the base module for extending the drawing assistance tool.

17. The drawing assistance tool of claim 13, wherein the top piece comprises a side part with an exterior magnetic connection point, wherein the ruler includes at least one magnetic fastening device at at least one end of the ruler, and wherein the at least one magnetic fastening device and the exterior magnetic connection point are magnetically connected to removably secure the ruler to the base module.

18. The drawing assistance tool of claim 13, wherein the ruler is a first ruler, the drawing assistance tool further comprises a second ruler, and wherein each of the first ruler and the second ruler comprises a first end with a first magnetic fastening device and a second end with a second magnetic fastening device.

19. The drawing assistance tool of claim 18, wherein the first magnetic fastening device of the first ruler is magnetically coupled to an exterior magnetic connection point of the top piece of the base module, and wherein the first magnetic fastening device of the second ruler is magnetically coupled to the second magnetic fastening device of the first ruler.
